(19) United States
(12) Patent Application Publication
(10) Pub. No.: US 2006/0133482 A1
(43) Pub. Date: Jun. 22, 2006

(54) Method for scalably encoding and decoding video signal

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/293,133

(22) Filed: Dec. 5, 2005

Related U.S. Application Data
(60) Provisional application No. 60/632,972, filed on Dec. 6, 2004.

(30) Foreign Application Priority Data
Jun. 30, 2005 (KR) 10-2005-0057566

(51) Int. Cl. H04N 7/12; H04N 11/04; H04B 1/66; H04N 11/02

(52) U.S. Cl. 375/240.08; 375/240.24

(57) ABSTRACT

A method for scalably encoding and decoding a video signal is provided. If a frame temporally coincident with a current frame in an enhanced layer including a target macroblock is not present (i.e., if there is a missing base layer frame) in a base layer when the target macroblock is predicted during encoding of the enhanced layer, the target macroblock is encoded in an intra mode using a past and/or future frame of the base layer prior to and subsequent to the current frame. Thus, inter-layer prediction can be applied even to a missing picture when a video signal is scalably encoded, thereby increasing coding efficiency.

### PRIORITY INFORMATION

This application claims priority under 35 U.S.C. § 119 on Korean Patent Application No. 10-2005-0057566, filed on Jun. 30, 2005, the entire contents of which are hereby incorporated by reference.

This application also claims priority under 35 U.S.C. §119 on U.S. Provisional Application No. 60/632,972, filed on Dec. 6, 2004; the entire contents of which are hereby incorporated by reference.

### BACKGROUND OF THE INVENTION

1. Field of the Invention

The present invention relates to scalable encoding and decoding of a video signal, and more particularly to a method for scalably encoding a video signal of an enhanced layer, which applies an inter-layer prediction method to a missing picture of a base layer, and a method for decoding such encoded video data.

2. Description of the Related Art

It is difficult to allocate high bandwidth, required for TV signals, to digital video signals wirelessly transmitted and received by mobile phones and notebook computers, which are widely used, and by mobile TVs and handheld PCs, which it is believed will come into widespread use in the future. Thus, video compression standards for use with mobile devices must have high video signal compression efficiencies.

Such mobile devices have a variety of processing and presentation capabilities so that a variety of compressed video data forms must be prepared. This indicates that a variety of qualities of video data having combinations of a number of variables such as the number of frames transmitted per second, resolution, and the number of bits per pixel must be provided for a single video source. This imposes a great burden on content providers.

Because of these facts, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding, scaling, and encoding processes, which causes some time delay in providing the requested data to the mobile device. The transcoding procedure also requires complex hardware and algorithms to cope with the wide variety of target encoding formats.

The Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded to video with a certain level of image quality.

Motion Compensated Temporal Filtering (MCTF) is an encoding scheme that has been suggested for use in the scalable video codec. However, the MCTF scheme requires a high compression efficiency (i.e., a high coding efficiency) for reducing the number of bits transmitted per second since the MCTF scheme is likely to be applied to transmission environments such as a mobile communication environment where bandwidth is limited.

Although it is ensured that part of a sequence of pictures encoded in the scalable MCTF coding scheme can be received and processed to video with a certain level of image quality as described above, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the main picture sequence is referred to as an enhanced or enhancement layer. Video signals of the base and enhanced layers have redundancy since the same video content is encoded into two layers with different spatial resolution or different frame rates. A variety of methods for predicting frames of the enhanced layer using frames of the base layer have been suggested to increase the coding efficiency of the enhanced layer.

One method is to code motion vectors of enhanced layer pictures using motion vectors of base layer pictures. Another method is to produce a predictive image of a video frame of the enhanced layer with reference to a video frame of the base layer temporally coincident with the enhanced layer video frame.

Specifically, in the latter method, macroblocks of the base layer are combined to constitute a base layer frame, and the base layer frame is upsampled so that it is enlarged to the same size as the size of a video frame of the enhanced layer, and a predictive image of a frame in the enhanced layer temporally coincident with the base layer frame or a predictive image of a macroblock in the temporally coincident enhanced layer frame is produced with reference to the enlarged base layer frame.

In another method, which is referred to as an inter-layer texture prediction method, if a macroblock of the base layer, which is temporally coincident with and spatially co-located with a current macroblock in the enhanced layer to be converted into a predictive image, has been coded in an intra mode, prediction of the current macroblock in the enhanced layer is performed with reference to the base layer macroblock after reconstructing an original block image of the base layer macroblock based on pixel values of a different area, which is an intra-mode reference of the base layer macroblock, and enlarging the reconstructed base layer macroblock to the same size as the size of a macroblock of the enhanced layer. This method is also referred to as an inter-layer intra base mode or an intra base mode (intra_BASE mode).

That is, this method reconstructs an original block image of an intra-mode macroblock of the base layer and enlarges the reconstructed base layer macroblock through upsampling, and then encodes the differences (i.e., residuals) of pixel values of a target macroblock of the enhanced layer from those of the enlarged macroblock into the target macroblock.

FIG. 1 illustrates the intra base mode. Application of the intra base mode to a target macroblock for encoding requires that a frame temporally coincident with an enhanced layer frame including the target macroblock be present in the base layer and that a block in the temporally coincident base layer frame corresponding to the target macroblock be coded in an intra mode.

However, a frame temporally coincident with the enhanced layer frame including the target macroblock may be absent in the base layer since the enhanced layer typically has a higher frame rate than the base layer. The absent frame is referred to as a “missing picture”. The intra base mode cannot be applied to such frames so that it is not effective in increasing coding efficiency.

### SUMMARY OF THE INVENTION

Therefore, the present invention has been made in view of the above problems, and it is an object of the present invention to provide a method for scalably encoding a video signal, which applies an inter-layer intra base mode even to missing pictures, thereby increasing coding efficiency, and a method for decoding a video signal encoded according to the encoding method.

In accordance with one aspect of the present invention, the above and other objects can be accomplished by the provision of a method for encoding a video signal, comprising scalably encoding the video signal according to a first scheme to output a bitstream of a first layer; and encoding the video signal according to a second scheme to output a bitstream of a second layer, wherein encoding the video signal according to the first scheme includes encoding an image block present in an arbitrary frame in an intra mode, based on a past frame and/or a future frame of the second layer prior to and/or subsequent to the arbitrary frame.

Preferably, encoding the video signal according to the first scheme further includes recording, in a header of the image block, information indicating that a predictive image of the image block has been encoded in an intra mode with reference to a corresponding block of the second layer.

Preferably, encoding the video signal according to the first scheme further includes determining whether or not a frame temporally coincident with the arbitrary frame is present in the bitstream of the second layer, and the method is applied when a frame temporally coincident with the arbitrary frame is not present in the second layer.

Preferably, encoding the video signal according to the first scheme further includes determining whether or not a corresponding block, which is present in a past frame and/or a future frame of the second layer prior to and/or subsequent to the arbitrary frame and which is located at substantially the same relative position in the frame as the image block, has been encoded in an intra mode, and wherein, when at least one of the corresponding blocks in the past and/or future frames of the second layer has been encoded in an intra mode, an interpolated block temporally coincident with the arbitrary frame is produced using the at least one corresponding block encoded in an intra mode, and the image block is encoded with reference to the produced interpolated block. Here, the produced interpolated block is preferably provided as a reference for encoding the image block after the produced interpolated block is enlarged to a size of the image block.

Preferably, encoding the video signal according to the first scheme further includes producing an interpolated frame temporally coincident with the arbitrary frame using a past frame and a future frame of the second layer prior to and subsequent to the arbitrary frame and encoding the image block with reference to a block corresponding to the image block present in the interpolated frame. Here, the interpolated frame is preferably produced using frames produced by reconstructing the past and future frames of the second layer, and the produced interpolated frame is preferably provided as a reference for encoding the image block after the produced interpolated frame is enlarged to a frame size of the first layer.

In accordance with another aspect of the present invention, there is provided a method for decoding an encoded video bitstream including a bitstream of a first layer encoded according to a first scheme and a bitstream of a second layer encoded according to a second scheme, the method comprising decoding the bitstream of the second layer according to the second scheme; and scalably decoding the bitstream of the first layer according to the first scheme using information decoded from the bitstream of the second layer, wherein decoding the bitstream of the first layer includes reconstructing an image block in an arbitrary frame of the first layer based on a past frame and/or a future frame of the second layer prior to and/or subsequent to the arbitrary frame if the image block has been encoded in an intra mode based on data of the second layer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an intra base mode (intra_BASE mode);

FIG. 2 is a block diagram of a video signal encoding apparatus to which a scalable video signal coding method according to the present invention is applied;

FIG. 3 illustrates elements in an EL encoder shown in FIG. 2 for temporal decomposition of a video signal at a certain temporal decomposition level;

FIG. 4 illustrates an embodiment according to the present invention in which residual data of a target macroblock in a current frame in the enhanced layer is obtained using a corresponding block, coded in an intra mode, in a base layer frame prior to and/or subsequent to the current frame;

FIG. 5 illustrates another embodiment according to the present invention in which residual data of a target macroblock in a current frame in the enhanced layer is obtained based on a temporally coincident frame of the base layer produced using reconstructed original images of past and future frames of the base layer prior to and subsequent to the current frame;

FIG. 6 is a block diagram of an apparatus for decoding a data stream encoded by the apparatus of FIG. 2; and

FIG. 7 illustrates elements in an EL decoder shown in FIG. 6 for temporal composition of H and L frame sequences of temporal decomposition level N into an L frame sequence of temporal decomposition level N−1.

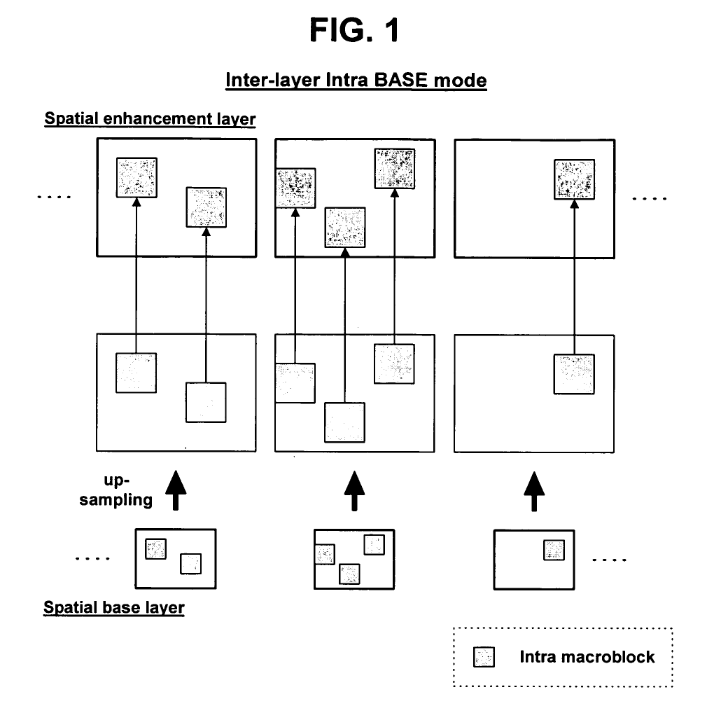

### DESCRIPTION OF THE PREFERRED EMBODIMENTS

Preferred embodiments of the present invention will now be described in detail with reference to the accompanying drawings.

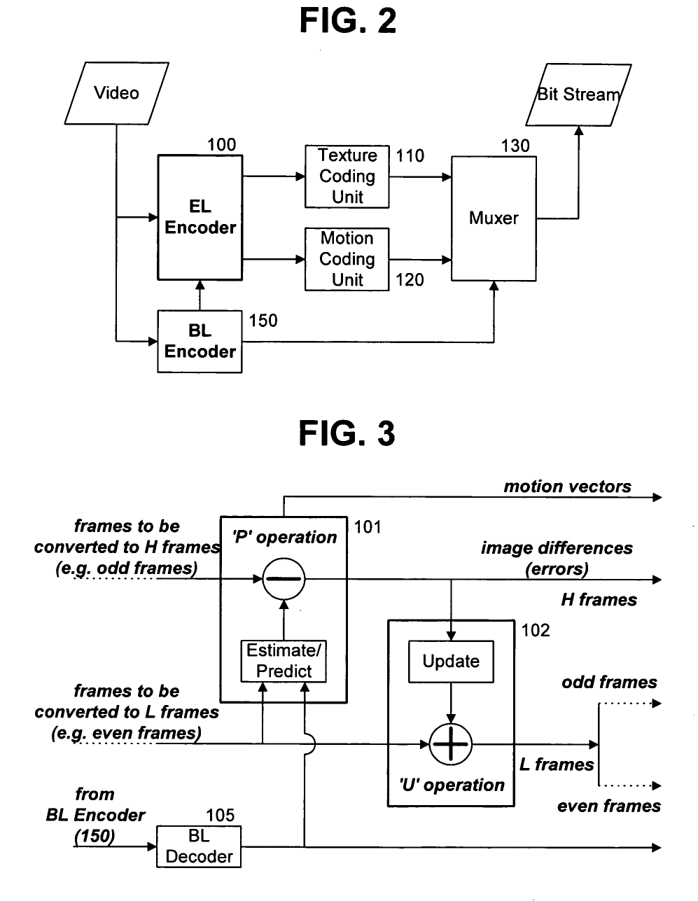

FIG. 2 is a block diagram of a video signal encoding apparatus to which a scalable video signal coding method according to the present invention is applied.

The video signal encoding apparatus shown in FIG. 2 comprises an enhanced layer (EL) encoder 100, a texture coding unit 110, a motion coding unit 120, a muxer (or multiplexer) 130, and a base layer (BL) encoder 150. The EL encoder 100 encodes an input video signal on a per macroblock basis in a scalable fashion according to a specified encoding scheme (for example, an MCTF scheme), and generates suitable management information. The texture coding unit 110 converts data of encoded macroblocks into a compressed bitstream. The motion coding unit 120 codes motion vectors of image blocks obtained by the EL encoder 100 into a compressed bitstream according to a specified scheme. The BL encoder 150 encodes an input video signal according to a specified scheme, for example, according to the MPEG-1, 2 or 4 standard or the H.261 or H.264 standard, and produces a small-screen picture sequence, for example, a sequence of pictures scaled down to 25% of their original size if needed. The muxer 130 encapsulates the output data of the texture coding unit 110, the small-screen sequence from the BL encoder 150, and the output vector data of the motion coding unit 120 into a predetermined format. The muxer 130 multiplexes and outputs the encapsulated data into a predetermined transmission format.

The EL encoder 100 performs a prediction operation on each macroblock in a video frame (or picture) by subtracting a reference block, found via motion estimation, from the macroblock. The EL encoder 100 also performs an update operation by adding an image difference between the reference block and the macroblock to the reference block.

The EL encoder 100 separates an input video frame sequence into frames, which are to have error values, and frames, to which the error values are to be added, for example, into odd and even frames. The EL encoder 100 performs prediction and update operations on the separated frames over a number of encoding levels, for example, until the number of L frames, which are produced by the update operation, is reduced to one for a group of pictures (GOP). FIG. 3 shows elements of the EL encoder 100 associated with prediction and update operations at one of the encoding levels.

The elements of the EL encoder 100 shown in FIG. 3 include an estimator/predictor 101, an updater 102, and a base layer (BL) decoder 105. The BL decoder 105 extracts encoding information, such as a macroblock mode and a frame rate, of a base layer stream containing a small-screen sequence encoded by the BL encoder 150, and decodes the encoded base layer stream to produce frames, each composed of one or more macroblocks. Through motion estimation, the estimator/predictor 101 searches for a reference block of each macroblock of a frame (for example, an odd frame), which is to contain residual data, in an adjacent even frame prior to or subsequent to the odd frame (inter-frame mode), in the odd frame (intra-mode), or in a temporally coincident frame in the base layer reconstructed by the BL decoder 105 (intra_BASE mode). The estimator/predictor 101 then performs a prediction operation to calculate an image difference (i.e., a pixel-to-pixel difference) of the macroblock from the reference block and a motion vector from the macroblock to the reference block. The updater 102 performs an update operation on a frame (for example, an even frame) including the reference block of the macroblock by normalizing the calculated image difference of the macroblock from the reference block and adding the normalized value to the reference block.

If no frame temporally coincident with the frame including the macroblock of the enhanced layer is present in the base layer reconstructed by the BL decoder 105 (i.e., if there is a missing picture) when the estimator/predictor 101 searches for the reference block of the macroblock in the base layer, the estimator/predictor 101 may produce a base layer frame temporally coincident with the frame including the macroblock using a frame(s), which is prior to and/or subsequent to the frame including the macroblock, from among frames of the base layer reconstructed by the BL decoder 105, and then search for the reference block in the produced temporally coincident base layer frame.

The operation carried out by the estimator/predictor 101 is referred to as a ‘P’ operation, and a frame produced by the ‘P’ operation is referred to as an ‘H’ frame. Residual data present in the ‘H’ frame reflects high frequency components of the video signal. The operation carried out by the updater 102 is referred to as a ‘U’ operation, and a frame produced by the ‘U’ operation is referred to as an ‘L’ frame. The ‘L’ frame is a low-pass subband picture.

The estimator/predictor 101 and the updater 102 of FIG. 3 may perform their operations on a plurality of slices, which are produced by dividing a single frame, simultaneously and in parallel, instead of performing their operations in units of frames. In the following description of the embodiments, the term ‘frame’ is used in a broad sense to include a ‘slice’, provided that replacement of the term ‘frame’ with the term ‘slice’ is technically equivalent.

More specifically, the estimator/predictor 101 divides each input video frame or each odd one of the L frames obtained at the previous level into macroblocks of a predetermined size. The estimator/predictor 101 then searches for a block, whose image is most similar to that of each divided macroblock, in temporally adjacent even frames prior to and subsequent to the current odd frame at the same temporal decomposition level, and produces a predictive image of each divided macroblock and obtains a motion vector thereof based on the found block. The estimator/predictor 101 codes the current macroblock in an intra mode using adjacent pixel values if the estimator/predictor 101 fails to find a block more highly correlated with the macroblock than an appropriate threshold correlation and if information regarding a temporally coincident frame is not present in encoding information of the base layer provided from the BL decoder 105 or if a corresponding block in a temporally coincident frame in the base layer is not in an intra mode. The term “corresponding block” refers to a block at the same relative position in the frame as the macroblock.

A block having the most similar image to a target block has the smallest image difference from the target block. The image difference of two blocks is defined, for example, as the sum or average of pixel-to-pixel differences of the two blocks. Of blocks having a predetermined threshold pixel-to-pixel difference sum (or average) or less from the target block, a block(s) having the smallest difference sum (or average) is referred to as a reference block(s).

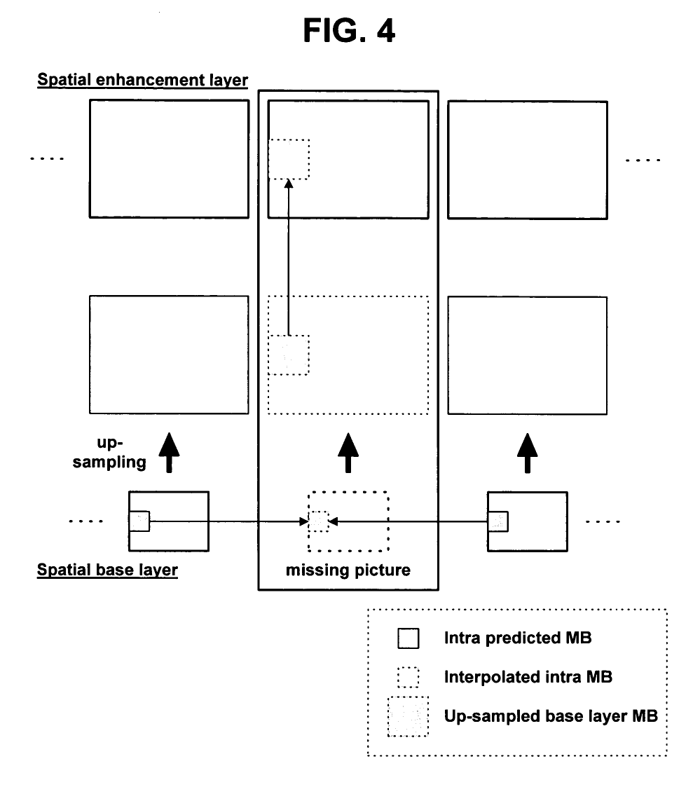

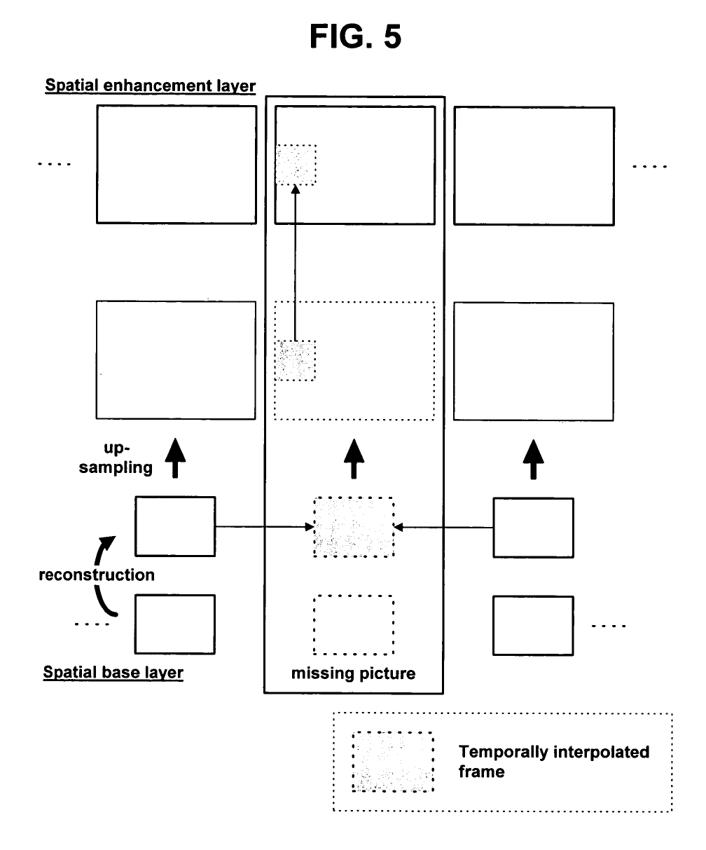

Embodiments according to the present invention, in which residual data of a macroblock in a current frame in the enhanced layer is produced using a base layer frame prior to and/or subsequent to the current frame if a base layer frame temporally coincident with the current frame is not present, will now be described with reference to FIGS. 4 and 5.

FIG. 4 illustrates an embodiment according to the present invention in which residual data of a target macroblock in a current frame in the enhanced layer is obtained using a corresponding block, coded in an intra mode, in a base layer frame prior to and/or subsequent to the current frame.

The embodiment of FIG. 4 can be applied when a corresponding block, which is present in a past frame and/or a future frame in the base layer prior to and/or subsequent to the current frame including the target macroblock in the enhanced layer and which is at the same relative position in the frame as the target macroblock, has been coded in an intra mode although a frame temporally coincident with the current frame is not present in the base layer, i.e., although there is a missing picture.

If both the corresponding blocks in the past and future frames have been coded in an intra mode, the estimator/predictor 101 reconstructs original block images of the two corresponding blocks based on pixel values of other areas in the past and future frames, which are respective intra-mode references of the two corresponding blocks, and interpolates between the reconstructed original block images of the two corresponding blocks to produce an interpolated intra block of the base layer temporally coincident with the current frame which is located midway between the past and future frames. The interpolation is, for example, based on averaging of at least part of the pixel values of the two reconstructed corresponding blocks, weighted according to a specific weighting method, or based on simple averaging thereof.

If only one of the two corresponding blocks in the past and future frames has been coded in an intra mode, the estimator/predictor 101 reconstructs an original block image of the corresponding block coded in an intra mode, based on pixel values of a different area in the frame, which is an intra-mode reference of the corresponding block, and regards the reconstructed corresponding block as an interpolated intra block of the base layer temporally coincident with the current frame. The estimator/predictor 101 then upsamples the interpolated intra block to enlarge it to the size of a macroblock in the enhanced layer.

The estimator/predictor 101 then produces residual data of the target macroblock in the enhanced layer with reference to the enlarged interpolated intra block.

FIG. 5 illustrates another embodiment according to the present invention in which residual data of a target macroblock in a current frame in the enhanced layer is obtained based on a temporally coincident frame of the base layer produced using reconstructed original images of past and future frames of the base layer prior to and subsequent to the current frame.

If a frame temporally coincident with the current frame including the target macroblock is not present in the base layer, i.e., if there is a missing picture, the estimator/predictor 101 reconstructs the past and future frames of the base layer to their original images and interpolates between the two reconstructed frames to produce a temporally interpolated frame corresponding to the missing picture, which is temporally coincident with the current frame, and then upsamples the temporally interpolated frame to enlarge it to the size of an enhanced layer frame. The interpolation is, for example, based on averaging of at least part of the pixel values of the two reconstructed frames, weighted according to a specific weighting method, or is based on simple averaging thereof.

The estimator/predictor 101 then produces residual data of the target macroblock in the enhanced layer with reference to a corresponding block in the enlarged interpolated frame, which is a macroblock at the same relative position in the frame as the target macroblock.

Further, the estimator/predictor 101 inserts information indicating the intra_BASE mode in a header area of the target macroblock in the current frame when producing the residual data of the target macroblock with reference to an interpolated corresponding block, which is temporally coincident with the current frame and which has been produced from the past frame and/or the future frame of the base layer through interpolation, or with reference to a corresponding block in a temporally coincident frame produced from the past and future frames of the base layer through interpolation.

The estimator/predictor 101 performs the above procedure for all macroblocks in the frame to complete an H frame which is a predictive image of the frame. The estimator/predictor 101 performs the above procedure for all input video frames or all odd ones of the L frames obtained at the previous level to complete H frames which are predictive images of the input frames.

As described above, the updater 102 adds an image difference of each macroblock in an H frame produced by the estimator/predictor 101 to an L frame having its reference block, which is an input video frame or an even one of the L frames obtained at the previous level.

The data stream encoded in the method described above is transmitted by wire or wirelessly to a decoding apparatus or is delivered via recording media. The decoding apparatus reconstructs the original video signal according to the method described below.

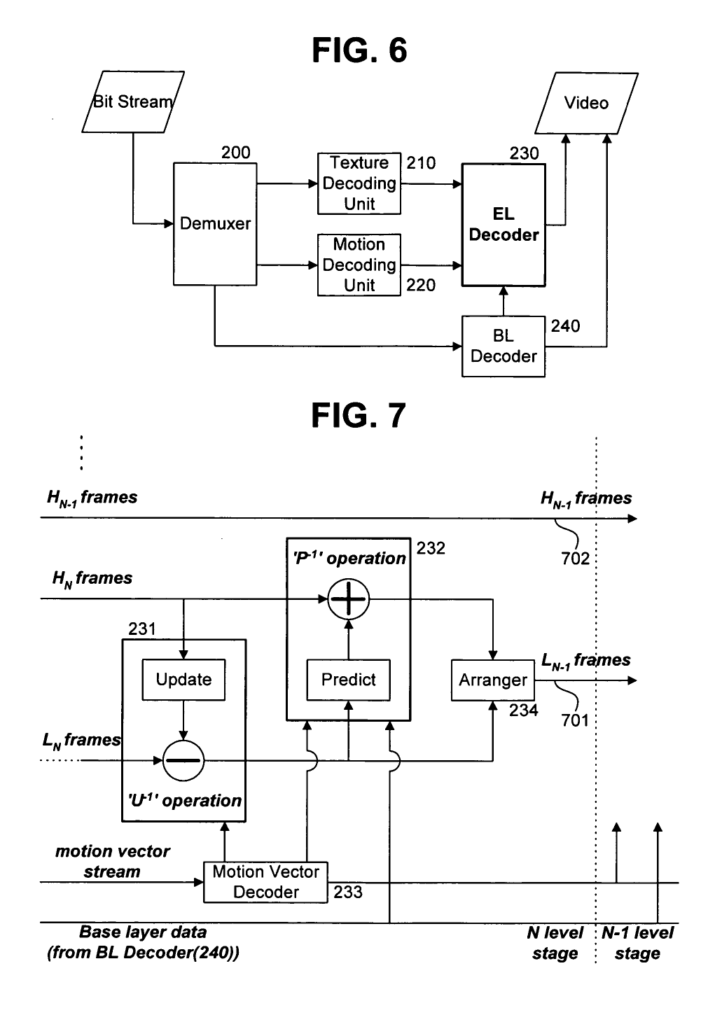

FIG. 6 is a block diagram of an apparatus for decoding a data stream encoded by the apparatus of FIG. 2. The decoding apparatus of FIG. 6 includes a demuxer (or demultiplexer) 200, a texture decoding unit 210, a motion decoding unit 220, an EL decoder 230, and a BL decoder 240. The demuxer 200 separates a received data stream into a compressed motion vector stream and a compressed macroblock information stream. The texture decoding unit 210 reconstructs the compressed macroblock information stream to its original uncompressed state. The motion decoding unit 220 reconstructs the compressed motion vector stream to its original uncompressed state. The EL decoder 230 converts the uncompressed macroblock information stream and the uncompressed motion vector stream back to an original video signal according to a specified scheme. The BL decoder 240 decodes a base layer stream according to a specified scheme (for example, the MPEG4 or H.264 standard). The EL decoder 230 uses encoding information of the base layer such as a frame rate and a macroblock mode and/or a decoded frame or macroblock of the base layer. The EL decoder 230 can convert the encoded data stream back to an original video signal, for example, according to an MCTF scheme.

The EL decoder 230 reconstructs an input stream to an original frame sequence. FIG. 7 illustrates main elements of an EL decoder 230 which is implemented according to the MCTF scheme.

The elements of the EL decoder 230 of FIG. 7 perform temporal composition of H and L frame sequences of temporal decomposition level N into an L frame sequence of temporal decomposition level N−1. The elements of FIG. 7 include an inverse updater 231, an inverse predictor 232, a motion vector decoder 233, and an arranger 234. The inverse updater 231 selectively subtracts difference values of pixels of input H frames from corresponding pixel values of input L frames. The inverse predictor 232 reconstructs input H frames into L frames having original images using both the H frames and the above L frames, from which the image differences of the H frames have been subtracted. The motion vector decoder 233 decodes an input motion vector stream into motion vector information of blocks in H frames and provides the motion vector information to an inverse updater 231 and an inverse predictor 232 of each stage. The arranger 234 interleaves the L frames completed by the inverse predictor 232 between the L frames output from the inverse updater 231, thereby producing a normal L frame sequence.

L frames output from the arranger 234 constitute an L frame sequence 701 of level N−1. A next-stage inverse updater and predictor of level N−1 reconstructs the L frame sequence 701 and an input H frame sequence 702 of level N−1 to an L frame sequence. This decoding process is performed over the same number of levels as the number of encoding levels performed in the encoding procedure, thereby reconstructing an original video frame sequence.

A reconstruction (temporal composition) procedure at level N, in which received H frames of level N and L frames of level N produced at level N+1 are reconstructed to L frames of level N−1, will now be described in more detail.

For an input L frame of level N, the inverse updater 231 determines all corresponding H frames of level N, whose image differences have been obtained using, as reference blocks, blocks in an original L frame of level N−1 updated to the input L frame of level N at the encoding procedure, with reference to motion vectors provided from the motion vector decoder 233. The inverse updater 231 then subtracts error values of macroblocks in the corresponding H frames of level N from pixel values of corresponding blocks in the input L frame of level N, thereby reconstructing an original L frame.

Such an inverse update operation is performed for blocks in the current L frame of level N, which have been updated using error values of macroblocks in H frames in the encoding procedure, thereby reconstructing the L frame of level N to an L frame of level N−1.

For a target macroblock in an input H frame, the inverse predictor 232 determines its reference blocks in inverse-updated L frames output from the inverse updater 231 with reference to motion vectors provided from the motion vector decoder 233, and adds pixel values of the reference blocks to difference (error) values of pixels of the target macroblock, thereby reconstructing its original image.

If information “intra_BASE mode” indicating that a macroblock in an H frame has been coded using a corresponding block in the base layer is included in a header of the macroblock, the inverse predictor 232 reconstructs an original image of the macroblock using a decoded base layer frame and header information in the stream provided from the BL decoder 240. The following is a detailed example of this process.

When a target macroblock in an H frame has been encoded in an intra_BASE mode, the inverse predictor 232 determines whether or not a frame having the same picture order count (POC) as that of the current H frame including the target macroblock is present in the base layer, based on a POC included in encoding information extracted by the BL decoder 105, in order to determine whether or not a frame temporally coincident with the current frame is present in the base layer, i.e., whether or not there is a missing picture. The POC of a picture is a number indicating the decoding order of the picture.

If a temporally coincident frame is present in the base layer, the inverse predictor 232 searches for a corresponding block in the temporally coincident base layer frame, which has been coded in an intra mode and which is located at the same relative position in the frame as the target macroblock, based on mode information of macroblocks included in the temporally coincident base layer frame provided from the BL decoder 240. The inverse predictor 232 then reconstructs an original block image of the corresponding block based on pixel values of a different area in the same frame which is an intra-mode reference of the corresponding block. The inverse predictor 232 then upsamples the corresponding block to enlarge it to the size of an enhanced layer macroblock, and reconstructs an original image of the target macroblock by adding pixel values of the enlarged corresponding block to difference values of pixels of the target macroblock.

On the other hand, if a temporally coincident frame is not present in the base layer, the inverse predictor 232 determines whether or not a corresponding block in a past frame and/or a future frame of the base layer prior to and/or subsequent to the current frame including the target macroblock has been coded in an intra mode, based on encoding information of the base layer provided from the BL decoder 240.

If both the corresponding blocks in the past and future frames of the base layer have been coded in an intra mode, the inverse predictor 232 reconstructs original block images of the two corresponding blocks based on pixel values of other areas in the past and future frames, which are respective intra-mode references of the two corresponding blocks, and interpolates between the reconstructed original block images of the two corresponding blocks to produce an interpolated intra block of the base layer temporally coincident with the current frame. The inverse predictor 232 then upsamples the interpolated intra block to enlarge it to the size of an enhanced layer macroblock, and reconstructs an original image of the target macroblock by adding pixel values of the enlarged intra block to difference values of pixels of the target macroblock.

If only one of the two corresponding blocks in the past and future frames has been coded in an intra mode, the inverse predictor 232 reconstructs an original block image of the corresponding block coded in an intra mode, based on pixel values of a different area in the same frame, which is an intra-mode reference of the corresponding block, and regards the reconstructed corresponding block as an interpolated intra block of the base layer temporally coincident with the current frame. The inverse predictor 232 then upsamples the interpolated intra block to enlarge it to the size of an enhanced layer macroblock, and reconstructs an original image of the target macroblock by adding pixel values of the enlarged intra block to difference values of pixels of the target macroblock.

In another method, the inverse predictor 232 reconstructs the past and future frames decoded and provided by the BL decoder 240 to their original images and interpolates between the two reconstructed frames to produce a temporally interpolated frame corresponding to a missing base layer picture, which is temporally coincident with the current frame. The inverse predictor 232 then upsamples the temporally interpolated frame to enlarge it to the size of an enhanced layer frame, and reconstructs an original image of the target macroblock by adding pixel values of a corresponding block in the enlarged interpolated frame to difference values of pixels of the target macroblock.

All macroblocks in the current H frame are reconstructed to their original images in the same manner as the above operation, and the reconstructed macroblocks are combined to reconstruct the current H frame to an L frame. The arranger 234 alternately arranges L frames reconstructed by the inverse predictor 232 and L frames updated by the inverse updater 231, and outputs such arranged L frames to the next stage.

The above decoding method reconstructs an MCTF-encoded data stream to a complete video frame sequence. In the case where the prediction and update operations have been performed for a group of pictures (GOP) N times in the MCTF encoding procedure described above, a video frame sequence with the original image quality is obtained if the inverse update and prediction operations are performed N times in the MCTF decoding procedure, whereas a video frame sequence with a lower image quality and at a lower bitrate is obtained if the inverse update and prediction operations are performed less than N times. Accordingly, the decoding apparatus is designed to perform inverse update and prediction operations to the extent suitable for the performance thereof.

The decoding apparatus described above can be incorporated into a mobile communication terminal, a media player, or the like.

As is apparent from the above description, a method for encoding and decoding a video signal according to the present invention applies inter-layer prediction even to a missing picture when the video signal is scalably encoded, thereby increasing coding efficiency.

Although the preferred embodiments of the present invention have been disclosed for illustrative purposes, those skilled in the art will appreciate that various improvements, modifications, substitutions, and additions are possible, without departing from the scope and spirit of the invention as disclosed in the accompanying claims.

What is claimed is:

1. A method for encoding a video signal, comprising:
scalably encoding the video signal according to a first scheme to output a bitstream of a first layer; and
encoding the video signal according to a second scheme to output a bitstream of a second layer,
wherein encoding the video signal according to the first scheme includes encoding an image block present in an arbitrary frame in an intra mode, based on a past frame and/or a future frame of the second layer prior to and/or subsequent to the arbitrary frame.

2. The method according to claim 1, wherein encoding the video signal according to the first scheme further includes determining whether or not a frame temporally coincident with the arbitrary frame is present in the bitstream of the second layer, and the method is applied when a frame temporally coincident with the arbitrary frame is not present in the second layer.

3. The method according to claim 2, wherein encoding the video signal according to the first scheme further includes determining whether or not a corresponding block, which is present in a past frame and/or a future frame of the second layer prior to and/or subsequent to the arbitrary frame and which is located at substantially the same relative position in the frame as the image block, has been encoded in an intra mode, and
wherein, when at least one of the corresponding blocks in the past and/or future frames of the second layer has been encoded in an intra mode, an interpolated block temporally coincident with the arbitrary frame is produced using the at least one corresponding block encoded in an intra mode, and the image block is encoded with reference to the produced interpolated block.

4. The method according to claim 3, wherein the produced interpolated block is provided as a reference for encoding the image block after the produced interpolated block is enlarged to a size of the image block.

5. The method according to claim 2, wherein encoding the video signal according to the first scheme further includes producing an interpolated frame temporally coincident with the arbitrary frame using a past frame and a future frame of the second layer prior to and subsequent to the arbitrary frame and encoding the image block with reference to a block corresponding to the image block present in the interpolated frame.

6. The method according to claim 5, wherein the interpolated frame is produced using frames produced by reconstructing the past and future frames of the second layer.

7. The method according to claim 6, wherein the produced interpolated frame is provided as a reference for encoding the image block after the produced interpolated frame is enlarged to a frame size of the first layer.

8. The method according to claim 1, wherein encoding the video signal according to the first scheme further includes recording, in a header of the image block, information indicating that a predictive image of the image block has been encoded in an intra mode with reference to a corresponding block of the second layer.

9. A method for decoding an encoded video bitstream including a bitstream of a first layer encoded according to a first scheme and a bitstream of a second layer encoded according to a second scheme, the method comprising:
decoding the bitstream of the second layer according to the second scheme; and
scalably decoding the bitstream of the first layer according to the first scheme using information decoded from the bitstream of the second layer,
wherein decoding the bitstream of the first layer includes reconstructing an image block in an arbitrary frame of the first layer based on a past frame and/or a future frame of the second layer prior to and/or subsequent to the arbitrary frame if the image block has been encoded in an intra mode based on data of the second layer.

10. The method according to claim 9, wherein decoding the bitstream of the first layer further includes determining whether or not the image block has been encoded in an intra mode based on data of the second layer, and the method is applied when a frame temporally coincident with the arbitrary frame is not present in the second layer.

11. The method according to claim 10, wherein the determination as to whether or not the image block has been encoded in an intra mode based on data of the second layer is based on mode information recorded in a header of the image block.

12. The method according to claim 10, wherein decoding the bitstream of the first layer further includes determining whether or not a corresponding block, which is present in a past frame and/or a future frame of the second layer prior to and/or subsequent to the arbitrary frame and which is located at substantially the same relative position in the frame as the image block, has been encoded in an intra mode, and
wherein, when at least one of the corresponding blocks in the past and/or future frames of the second layer has been encoded in an intra mode, an interpolated block temporally coincident with the arbitrary frame is produced using the at least one corresponding block encoded in an intra mode, and the image block is reconstructed using the produced interpolated block.

13. The method according to claim 12, wherein the produced interpolated block is provided as a reference for reconstructing the image block after the produced interpolated block is enlarged to a size of the image block.

14. The method according to claim 10, wherein decoding the bitstream of the first layer further includes producing an interpolated frame temporally coincident with the arbitrary frame using a past frame and a future frame of the second layer prior to and subsequent to the arbitrary frame and reconstructing the image block using a block corresponding to the image block present in the interpolated frame.

15. The method according to claim 14, wherein the interpolated frame is produced using frames produced by reconstructing the past and future frames of the second layer.

16. The method according to claim 15, wherein the produced interpolated frame is provided as a reference for reconstructing the image block after the produced interpolated frame is enlarged to a frame size of the first layer.
